(19) United States
(12) Patent Application Publication
(10) Pub. No.: US 2001/0038595 A1
(43) Pub. Date: Nov. 8, 2001

(54) Information recording medium reproducing apparatus and method

(76) Inventors: Yoshinori Yamada, Saitama (JP); Koji Asao, Saitama (JP); Yasuhiro Shinkai, Saitama (JP); Tetsuya Uchiyma, Saitama (JP); Kazuo Kobayashi, Saitama (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/765,372

(22) Filed: Jan. 22, 2001

(30) Foreign Application Priority Data
Jan. 20, 2000 (JP) 2000-011305

(51) Int. Cl. G11B 17/04

(52) U.S. Cl. 369/77.1

(57) ABSTRACT

An information recording and/or reproducing apparatus is provided that includes a recording and/or reproducing device, a transportation device, a power source, and a controller. The recording and/or reproducing device records and/or reproduces information from an information medium, and the transportation device transports the information medium along a transportation path between a loading area and the recording and/or reproducing device. The power source supplies power to the transportation device, and the transportation device imparts a first load on the power source when the transportation device transports the information medium along a first portion of the transportation path. Also, the transportation device imparts a second load on the power source when the transportation device transports the information medium along a second portion of the transportation path. The controller applies a first driving signal to drive the power source when the transportation device transports the information medium along the first portion of said transportation path and applies a second driving signal to drive the power source when the transportation device transports the information medium along the second portion of the transportation path. Also, a method performed by the apparatus is also provided.

### BACKGROUND OF THE INVENTION

1. Field of the Invention

The present invention relates to a disk reproducing apparatus and method for reproducing information recorded on a disk such as a compact disk (“CD”) or a digital video disk (“DVD”). More particularly, the present invention relates to an apparatus and method for loading a disk to a reproduction position and ejecting a disk from the reproduction position.

The present application claims priority from Japanese Application No. 2000-011305, the disclosure of which is incorporated herein by reference for all purposes.

2. Description of the Related Art

Recently, the popularity of a “slot-in type” disk reproducing apparatus has rapidly increased. In such a reproducing apparatus, a disk (e.g. a CD or a DVD) containing recorded information (e.g. audio, video, or software programming information) is directly loaded into the apparatus by inserting the disk through an insertion hole. An example of a “slot-in type” disk reproducing apparatus is illustrated in FIG. 8, which schematically illustrates a top view of a disk player P0.

As shown in the figure, the disk player P0 comprises an insertion hole 101, a turntable 102, and a loading device 103. The insertion hole 101 is located on the front side of the disk player P0, and a disk can be loaded into the player P0 by inserting the disk through the insertion hole 101. When the disk is completely loaded in the player P0, it is mounted on the turntable 102, and the turntable 102 rotates the disk so that information can be reproduced from the disk. Also, although not specifically shown in FIG. 8, the turntable 102 is connected to a rotating shaft of a spindle motor that is attached to a chassis of the disk player P0.

As described in more detail below, the loading device 103 comprises a loading and unloading mechanism that moves the disk from an insertion position to a housed position during an insertion operation and that moves the disk away from the housed position to an ejection position during an ejection operation. Also, the loading device 103 comprises a clamping mechanism that sequentially moves the disk from the housed position to a reproduction position and clamps the disk on the turntable 102 during a clamping operation and that sequentially releases the disk from the turntable 102 and moves the disk from the reproduction position to the housed position during an unclamping operation.

The disk player P0 also comprises a DC motor 108, a detector 104, and a detector 105. The DC motor 108 acts as a power source for driving the loading and unloading mechanism and for driving the clamping mechanism. The detector 104 detects whether or not the disk is located at the insertion position when it is initially inserted into the disk player P0, and the detector 105 detects whether or not the disk is located at the ejection position when it is ejected from the disk player P0. Also, the disk player comprises a controller (not shown) which transmits and/or receives various signals to and/or from the various components for controlling the overall operations of the disk player P0.

In order to load a disk in the disk player P0 during a disk loading operation, the disk is inserted into the insertion hole 101. After the disk is inserted, the loading and unloading mechanism of the loading device 103 moves the disk from the insertion position to the housed position. After the disk reaches the housed position, the clamping mechanism moves the disk to the reproduction position on the turntable 102 and performs a clamping operation to clamp the disk to the turntable 102. When the disk is clamped to the turntable 102, the disk loading operation is completed.

After the disk is loaded in the disk player P0, an EJECT instruction can be input to the controller of the disk player P0 to initiate a disk unloading operation and eject the disk from the player P0. When the EJECT instruction is input (e.g. when a user presses an EJECT button of the disk player P0), the clamping mechanism sequentially performs the clamp releasing operation to unclamp the disk from the turntable 102 and moves the disk from the reproduction position to the housed position. When the disk reaches the housed position, the loading and unloading mechanism performs the ejection operation to move the disk from the housed position to the ejection position. When the disk reaches the ejection position, the disk unloading operation of the disk is completed.

FIGS. 9A and 9B and FIGS. 10A and 10B are views showing the various positions of the disk during the disk loading and unloading operations of the disk player P0. Specifically, FIG. 9A illustrates the disk player P0 when the disk is located at the insertion position, and FIG. 9B illustrates the disk player P0 when the disk is located at the housed position. Also, FIG. 10A shows the disk player P0 when the disk is located at the reproduction position, and FIG. 10B shows the disk player P0 when the disk is located at the ejection position. As shown in FIGS. 9B and 10A, the horizontal position of the disk when it is located at housed position is similar to the horizontal position of the disk when it is loaded at the reproduction position. However, in the housed position, the disk is located above the turntable 102, whereas in the reproduction position, the disk is located on the turntable 102 below the housed position.

The loading and unloading mechanism of the loading device 103 comprises rotating rollers 106 and 107 disposed near the insertion hole 101 and comprises various gears and/or cams. The gears and/or cams are operably connected between the rollers 106 and 107 and the DC motor 108 and transmit a driving force of the DC motor 108 to the rollers 106 and 107. Furthermore, the operation and rotation of the DC motor 108 is controlled by the controller.

The clamping mechanism comprises cams and/or gears which transmit a driving force of the DC motor 108 to vertically move the rollers 106 and 107 with respect to the turntable 102 so that the rollers 106 and 107 can move the disk from (or to) the housing position to (or from) the reproduction position. Also, the clamping mechanism comprises a damper (not shown) that clamps the disk to the turntable 102 when the disk is located in the reproduction position so that the disk rotates in conjunction with the turntable 102. Also, when the disk is clamped to the turntable 102 and the EJECT instruction is received, the damper unclamps the disk from the turntable 102. Furthermore, gears and/or cams are provided to transmit a driving force generated by the DC motor 108 to the damper and causes the damper to unclamp the disk from the turntable 102.

As further shown in FIGS. 8 to 10B, the detector 104 is located at a predetermined position between the insertion hole 101 and the rotating rollers 106 and 107 and detects when a disk is inserted into the insertion hole 101 and located at the insertion position. Furthermore, the detector 104 may be an optical detector that optically detects when the disk is located at the insertion position. In the figures, the detector 104 is indicated by a circular detection region, and when the disk is inserted into the insertion hole 101 and enters the detection region, the detector 104 detects the disk and supplies a corresponding detection signal (e.g. a logic “1”) to the controller. As a result, the controller can determine when the disk is inserted into the insertion hole 101 and is located at the insertion position (i.e. is located within the detection region of the detector 104).

Also, the detector 105 is provided on a path along which the disk moves from the reproduction position to the ejection position. As in the case of the detector 104, the detector 105 may be an optical detector and may optically detect when the disk is located at the ejection position. In the figures, the detector 105 is indicated by a circular detection region, and when the disk is located at the ejection position, the disk is no longer contained in the detection region of the detector 105. Thus, when the detector 105 no longer detects the optical presence of the disk, it supplies a corresponding detection signal (e.g. a logic “0”) to the controller. Thus, the controller can determine when the disk has reached the ejection position (i.e. has moved outside the detection region of the detector 105).

The loading device 103 also contains a lever slide mechanism, and the lever slide mechanism includes an arm 109, a first lever 110, a coupling member 111, a second lever 112, and a lever switch 113. As best shown in FIG. 8, the arm 109 is rotatably attached to the chassis of the disk player P0 via a shaft, and one end of the arm 109 is coupled to one end of the first lever 110. Furthermore, the other end of the arm 109 has an engagement portion 109a that engages the disk when it is loaded to and unloaded from the disk player P0. Specifically, when the disk is moved from the insertion position to the housed position, it contacts the engagement portion 109a of the arm 109 sometime before it reaches the housed position. After the disk contacts the engagement portion 109a, the disk pushes the engagement portion 109a and rotates the arm 109 clockwise around the shaft as it continues to move to the housed position. As the arm 109 rotates clockwise around the shaft, the first lever 110 moves downward in the Y direction shown in FIG. 8.

The first lever 110 comprises a rack 110a, and when the lever 110 moves downward in the Y direction, the rack 110a moves towards and engages a gear 114. The gear 114 is coupled to the DC motor 108 and transmits the power (or torque) from the DC motor 108 to the rack 110a when the rack 110a engages the gear 114. As a result, when the rack 110a engages the gear 114, the rack 110a (and thus the lever 110) is driven by the gear 114 and moves in the Y direction based on the rotation of the gear 114.

The other end of the first lever 110 is coupled to one end of the second lever 112 via the coupling member 111. The coupling member 111 is coupled to a shaft and is rotatably disposed around the shaft. Thus, when the first lever 110 moves in the Y direction in FIG. 8, the coupling member 111 rotates around its shaft and causes the second lever 112 to move in the X direction in FIG. 8. The other end of the second lever contains an engagement portion 112a, and the engagement portion 112a selectively turns the lever switch 113 ON or OFF based on the position of the second lever 112. Specifically, when the second lever 112 moves in the X direction such that the engagement portion 112a moves adjacent to the switch 113, the switch 113 is turned ON. On the other hand, when the second lever 112 moves such that the engagement portion 112a is no longer adjacent to the switch 113, the switch 113 is turned OFF.

Based on the above construction of the lever slide mechanism, when the loading and unloading mechanism moves the disk from the insertion position to the housed position, the disk contacts the engagement portion 109a before it reaches the housed position. As the disk continues to move towards the housed position, the arm 109 is rotated around the shaft, and the first lever 110 is moved downward in the Y direction shown in FIG. 8.

As shown in FIG. 9B, when the disk reaches the housed position, the first lever 110 is moved downward such that rack 110a engages the gear 114. At such time, the rack 110a is pulled downward in the Y direction by the gear 114 since the gear 114 is rotated and driven by the driving force of the DC motor 108. Consequently, the first lever 110 is pulled downward in the Y direction as the gear 114 rotates, and the arm 109 is pulled by the first lever 110 and further rotated clockwise around its shaft. As a result, the engagement portion 109a disengages the disk after the disk reaches the housed position.

Also, at the time that the rack 110a engages the gear 114, the driving force of the DC motor 108 begins to be transmitted to the clamping mechanism of the loading device 103 so that the clamping operation can be performed. Since the load of clamping mechanism is applied to the DC motor when the clamping operation begins, the time at which the rack 110a engages the gear 114 is a time at which the load on the DC motor 108 changes.

As mentioned above, when the rack 110a engages the gear 114 as the disk moves to the housed position, the first lever 110 is pulled downward in the Y direction. When the first lever 110 is pulled downward, the coupling member 111 rotates clockwise around its shaft and moves the second lever 112 to the left in the X direction shown in FIG. 8. As the second lever 112 continues to move to the left, the engagement portion 112a moves adjacent to the lever switch 113 at the time that the clamping operation performed by the clamping mechanism is completed. Since the engagement portion 112a switches the lever switch 113 from the OFF state to the ON state when it moves adjacent to the switch 113, the switch 113 turns ON when the clamping operation is completed and generates a switching signal that equals a logic “1”. The controller inputs the switching signal, and thus, the controller can determine when the disk reaches the reproduction position and when the clamping operation is completed by evaluating the switching signal.

Based on the configuration of the disk player P0 described above, when the disk is inserted into the insertion hole 101 by the user or other means, the controller determines that the disk is located at the insertion position by evaluating the detection output of the detector 104. When the controller determines that the disk is located at the insertion position, it instructs the DC motor 108 to rotate in a direction such that the rollers 106 and 107 move the disk from the insertion position towards the housed position (FIG. 9B). When the disk reaches the housed position (and the gear 114 engages the rack 110a), the controller drives the clamping mechanism such that the disk is lowered to the reproduction position (FIG. 10A) and clamped to the turntable 102. After the disk is clamped, the controller instructs a spindle motor (not shown) of the turntable 102 to rotate, and consequently, the disk is rotated at a predetermined speed and information is reproduced from the disk by a reproduction device (not shown).

When this disk is in the reproduction position and an EJECT instruction is input by pressing an EJECT button or the like on the disk player P0, the controller instructs the DC motor 108 to rotate in a particular direction and drive the clamping mechanism to unclamp the disk from the turntable 102 and to move the disk from the reproduction position to the housed position (FIG. 9B). After the disk is moved to the housed position, the controller instructs the loading and unloading mechanism to perform the ejecting operation to move the disk from the housed position to the ejection position. (FIG. 10B). When the disk reaches the ejection position, it is held such that it partially protrudes outside of the player P0 from the insertion hole 101 as shown in FIG. 10B.

The disk loading operation and the disk unloading operation of the disk player P0 will be described below in more detail with reference to FIGS. 9A-13. FIG. 11 shows a flowchart of a disk loading procedure executed by the controller during the disk loading operation, and FIG. 12 shows a flowchart of a disk unloading procedure executed by the controller during the disk unloading operation. Also, FIG. 13 illustrates a waveform diagram of a driving voltage applied to the DC motor 108 by the controller during the disk loading operation and the disk unloading operation. More specifically, FIG. 13 shows waveform of the driving voltage when the disk unloading operation is performed after the disk loading operation.

Disk Loading Operation

After power is initially supplied to the disk player P0 and before a disk is inserted into the insertion slot 101, the detector 104 does not detect the presence of a disk at the insertion position, the detector 105 does not detect the presence of a disk at the ejection position, and the lever switch 113 does not detect the presence of the disk at the reproduction position. Thus, the controller determines that a disk is not present within the player P0 and does not drive the DC motor 108.

Accordingly, as shown in FIG. 11, after power is initially supplied to the disk player P0, the controller determines if the detection output of the detector 104 equals a logic “1” (e.g. if the detector 104 detects the presence of a disk) or if the detection output of the detector 104 equals a logic “0” (e.g. if the detector 104 does not detect the presence of a disk). (Operation S1). If the detection output of the detector 104 is equal to a logic “0”, the controller determines that a disk is not located at the insertion position of the disk player P0, and operation S1 is repeated. If the detection output of the detector 104 equals a logic “1”, the controller determines that the disk is located at the insertion position (FIG. 9A). (Operation S1).

When the controller determines that a disk is located at the insertion position, the controller applies a constant driving voltage +V₀ the DC motor 108 at a time “a” (FIG. 13) to instruct the motor 108 to rotate in a first direction. (Operation S2). When the DC motor 108 rotates in the first direction, the rollers 106 and 107 rotate such that they move the disk from the insertion position towards the housing position (FIG. 9B).

After the constant driving voltage +V₀ is applied to the motor 108, the controller determines if the lever switch 113 is ON and is outputting a switching signal that equals a logic “1” (Operation S3). If the switching signal equals a logic “1” (i.e. if the disk is located in the reproduction position (FIG. 10A) and clamped to the turntable 102), the controller stops supplying the driving voltage +V₀ to the DC motor 108 at a time “b” (FIG. 13), and the motor 108 stops rotating. (Operation S4). On the other hand, if the switching signal equals a logic “0” (i.e. if the disk is not located in the reproduction position (FIG. 10A) and is not clamped to the turntable 102), the controller repeats operation S3.

During the operation S2, when the rollers 106 and 107 are rotated by the DC motor 108, the disk is pulled into the disk player P0 through the insertion slot 101 and is transported horizontally towards the housed position (FIG. 9B). As the disk is being moved to the housed position, it engages the engagement portion 109a of the arm 109 before it reaches the housed position. Then, the rollers 106 and 107 continue to move the disk horizontally to the housed position and cause the disk to push the arm 109 and rotate it around its shaft.

When the disk reaches the housed position, the rack 110a engages the gear 114, and the DC motor 108 drives the gear 114 such that the rack 110a and the first lever 110 move downward in the Y direction shown in FIG. 8. Also, at the time that the gear 114 engages the rack 110a and begins to move the first lever 110 downward, the driving force of the DC motor 108 is transmitted to the clamping mechanism. When the clamping mechanism receives the driving force from the DC motor 108, it moves the rotating rollers 106 and 107 downward, along with the disk, and mounts the disk on the turntable 102. After the disk is clamped to the disk, the rotating rollers 106 and 107 are further lowered so that they are separated from the disk, and the clamping operation is completed. After such operations, the disk is located at the reproduction position (FIG. 10A).

As shown in FIG. 10A, when the disk is in the reproduction position after the clamping operation, the engagement portion 112a of the second lever 112 is located adjacent to the lever switch 113 and turns ON the lever switch 113. Thus, the switching signal output from the switch 113 to the controller equals a logic “1”, and the controller stops applying the driving voltage +V₀ to the DC motor 108. Thus, when the controller detects that the lever switch 113 is switched from OFF to ON, it determines that the clamping operation of the disk is completed and stops driving the DC motor 108. As a result, the disk loading operation is completed.

Disk Unloading Operation

When a disk is located in the reproduction position (FIG. 10A) and the clamping operation by the clamping mechanism has been completed, an EJECT instruction may be input to eject the disk from the disk player P0 by pressing an EJECT button or the like on the disk player P0. When the EJECT button is pressed, the controller applies a constant driving voltage −V₀ to the DC motor 108 to drive the motor 108 in a second direction at time “c” (FIG. 13). The driving voltage −V₀ has a magnitude that is equal to and a polarity that is opposite to the driving voltage +V₀ described above. Furthermore, the second direction in which the motor 108 is driven is opposite to the first direction mentioned above. When the DC motor 108 rotates in the second direction, the clamping mechanism performs a clamp releasing operation to release the disk from the turntable 102 and raises the disk from the reproduction position (FIG. 10A) to the housed position (FIG. 9B). Furthermore, in order to raise the disk from the reproduction position to the housed position, the rollers 106 and 107 are raised upward, positioned under the disk on the turntable 102, and lift the disk up from the turntable 102 to the housed position. After the rollers 106 and 107 lift the disk up to the housed position, the vertical movement of the rollers 106 and 107 ceases, and the clamp releasing operation of the clamping mechanism is completed. At the same time that the clamp releasing operation is being performed, the gear 114 moves the rack 110a and the first lever 110 upwards in the Y direction shown in FIG. 8, and the rack 110a becomes disengaged from the gear 114 at approximately the time when the clamp releasing operation is completed and the disk reaches the housed position. After the disk is located in housed position, the rotation of the DC motor 108 is coupled to the rollers 106 and 107 so that they rotate and horizontally move the disk from the housed position towards the ejection position (FIG. 10B).

As shown in FIG. 12, after the driving voltage −V₀ is supplied to the DC motor at a time “c” (FIG. 13). (Operation S11), the controller evaluates the detection output signal from the detector 105 to determine if the signal equals a logic “0” (i.e. if the disk has reached the ejection position) or if the signal equals a logic “1” (i.e. if the disk has not reached the ejection position). (Operation S12). If the controller determines that the disk is not located at the ejection position, operation S12 is repeated. On the other hand, if the controller determines that the disk is located at the ejection position, it stops driving the DC motor 108 at the time “d” (FIG. 13). (Operation S13). As a result, the ejecting operation of the disk is completed.

In the disk player P0 described above, the loading and unloading mechanism and the clamping mechanism are driven by a single DC motor 108. As a result, the disk loading operation and the disk ejecting operation are performed to selectively move the disk to the insertion position, housed position, reproduction position, and ejection position. Thus, the controller applies the driving voltage +V₀ to the motor 108 when the disk is moved from the insertion position to the housed position and applies the same constant driving voltage +V₀ to the DC motor 108 when the disk is moved from the housed position to the reproduction position. Similarly, the controller applies the driving voltage −V₀ to the motor 108 when the disk is moved from the reproduction position to the housed position and applies the same constant driving voltage −V₀ to the DC motor 108 when the disk is moved from the housed position and the ejection position. In other words, the same driving voltage +V₀ (or −V₀) is supplied to the DC motor 108 when the motor 108 drives the loading and unloading mechanism and when the motor 108 drives the clamping mechanism.

However, when the DC motor 108 is driving the clamping mechanism to move the disk to the reproduction position and clamp it to the turntable 102 (or unclamp the disk from the turn table and move it to the housed position), the load on the motor 108 is substantially greater than when the motor 108 is driving the loading and unloading mechanism to move the disk from the insertion position to the housed position (or to move the disk from the housed position to the ejection position). Since the loading and unloading mechanism is driven by the motor 108 at a constant torque, the operation of the motor 108 becomes unstable when the motor 108 switches from driving the loading and unloading mechanism to driving the clamping mechanism.

More specifically, the clamping mechanism requires a greater driving force than the loading and unloading mechanism. As a result, the load applied to the DC motor 108 when the motor 108 drives the clamping means is larger than when it drives the loading and unloading mechanism. Thus, the magnitude of the driving voltage +V₀ (or −V₀) applied to the DC motor 108 is determined so that it is able to adequately drive the clamping mechanism, which requires a large driving force. Accordingly, the driving voltage +V₀ (or −V₀) drives the motor 108 at an appropriate revolution rate so that the motor 108 smoothly drives the clamping mechanism to perform the clamping operation and the clamp releasing operation.

However, since the motor 108 is always driven by the constant driving voltage +V₀ (or −V₀), the same driving voltage +V₀ (or −V₀) still drives the motor 108 when the load of the DC motor 108 is substantially reduced when the motor 108 switches from driving the clamping mechanism to driving the loading and unloading mechanism. As a result, the revolution rate of the motor 108 is dramatically increased when it switches from driving the clamping mechanism to driving the loading and unloading mechanism. At such time, the DC motor 108 generates an abnormal sound and brush noise when the DC motor 108 is frequently rotated at such high speeds, and thus, the operation of the disk player P0 is substantially degraded. Also, recently, the size of the disk player P0 has been substantially reduced, and in order to achieve such a reduction in size, the size of the motor 108 has likewise been reduced. However, in a small motor 108, the driving voltage +V₀ (or −V₀) must drive the motor 108 at a very high revolution rate to enable it to adequately drive the clamping mechanism, which imparts a heavy load on the motor 108. In such case, when the small motor 108 switches from driving the clamping mechanism to driving the loading and unloading mechanism, an even larger abnormal sound and brush noise are generated.

### SUMMARY OF THE INVENTION

An object of the invention is to provide a recording and/or reproducing apparatus which overcomes the above and other problems contained in conventional recording and/or reproducing apparatuses.

An additional object of the invention is to provide a recording and/or reproducing method which overcomes the above and other problems contained in conventional recording and/or reproducing methods.

Another object of the invention is to provide a recording and/or reproducing apparatus that suppresses abnormal sound and noise of a power source even when a load of the power source changes.

Yet another object of the invention is to provide a recording and/or reproducing method that suppresses abnormal sound and noise of a power source even when a load of the power source changes.

In order to achieve the above and other objects, an information recording and/or reproducing apparatus is provided. The apparatus comprises: a recording and/or reproducing device that reproduces information from an information medium; a transportation device that transports said information medium along a transportation path between a loading area and said recording and/or reproducing device; a power source that supplies power to said transportation device, wherein said transportation device imparts a first load on said power source when said transportation device transports said information medium along a first portion of said transportation path, and wherein said transportation device imparts a second load on said power source when said transportation device transports said information medium along a second portion of said transportation path; and a controller that applies a first driving signal to drive said power source when said transportation device transports said information medium along said first portion of said transportation path and that applies a second driving signal to drive said power source when said transportation device transports said information medium along said second portion of said transportation path, wherein said first driving signal is different than said second driving signal.

In order to further achieve the above and other objects, a method of transporting an information medium via a transportation device along a transportation path between a loading area and a recording and/or reproducing area of an information recording and/or reproducing apparatus is provided. The method comprises: (a) determining if said information medium is to be transported along a first portion of said transportation path; (b) if said information medium is to be transported along said first portion of said transportation path, supplying a first drive signal to a power source of said transportation device; (c) determining if said information medium is to be transported along a second portion of said transportation path; and (d) if said information medium is to be transported along said second portion of said transportation path, supplying a second drive signal to said power source, wherein said second drive signal is different from said first drive signal.

### BRIEF DESCRIPTION OF THE DRAWINGS

The above and other objectives and advantages of the present invention will become more apparent by describing in detail preferred embodiments thereof with reference to the attached drawings in which:

FIG. 1 shows a schematic structure of a main portion of a disk player of an illustrative embodiment of the present invention;

FIG. 2A shows a first position of a disk within the disk player during a disk loading operation;

FIG. 2B shows a second position of a disk within the disk player during a disk loading operation;

FIG. 3A shows a first position of a disk within the disk player during a disk unloading operation;

FIG. 3B shows a second position of a disk within the disk player during a disk unloading operation;

FIG. 4 is a block diagram of a rotation controller of the disk player shown in FIG. 1;

FIG. 5 is a flowchart of a disk loading operation performed by the disk player shown in FIG. 1;

FIG. 6 is a flowchart of a disk unloading operation performed by the disk player shown in FIG. 1;

FIG. 7 is a waveform diagram of a driving voltage supplied to a power source of the disk player shown in FIG. 1;

FIG. 8 shows a schematic structure of a main portion of a slot-in type disk player;

FIG. 9A shows a first position of a disk within the disk player during a disk loading operation;

FIG. 9B shows a second position of a disk within the disk player during a disk loading operation;

FIG. 10A shows a first position of a disk within the disk player during a disk unloading operation;

FIG. 10B shows a second position of a disk within the disk player during a disk unloading operation;

FIG. 11 is a flowchart of a disk loading operation performed by the disk player shown in FIG. 8;

FIG. 12 is a flowchart of a disk unloading operation performed by the disk player shown in FIG. 8; and

FIG. 13 is a waveform diagram of a driving voltage supplied to a power source of the disk player shown in FIG. 8.

### DETAILED DESCRIPTION OF THE PREFERRED EMBODIMENTS

The following description of the preferred embodiments discloses specific configurations, components, process operations. However, the preferred embodiments are merely examples of the present invention, and thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, components, and operations of the present invention that would have been known to one skilled in the art are omitted for the sake of clarity and brevity.

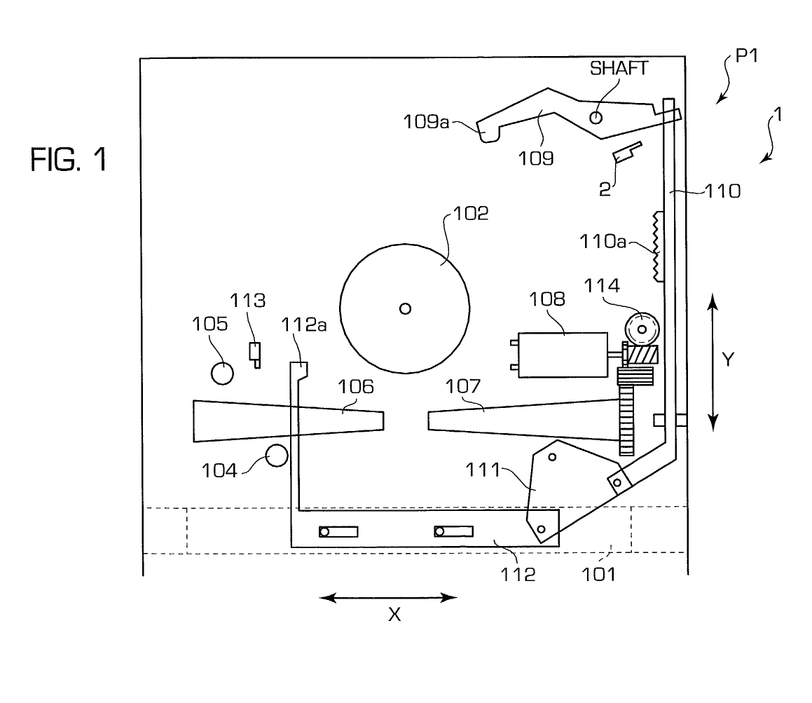

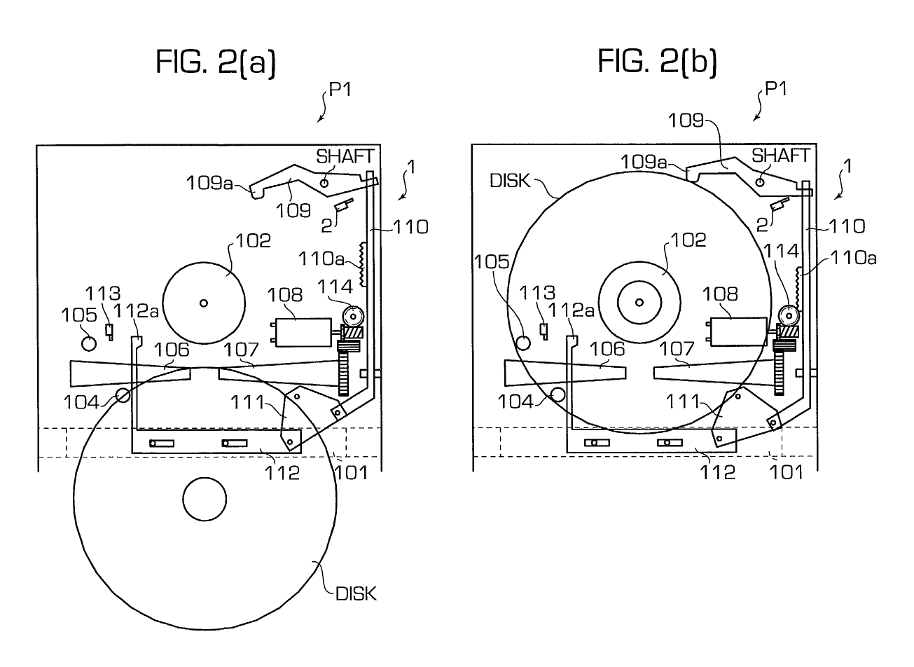

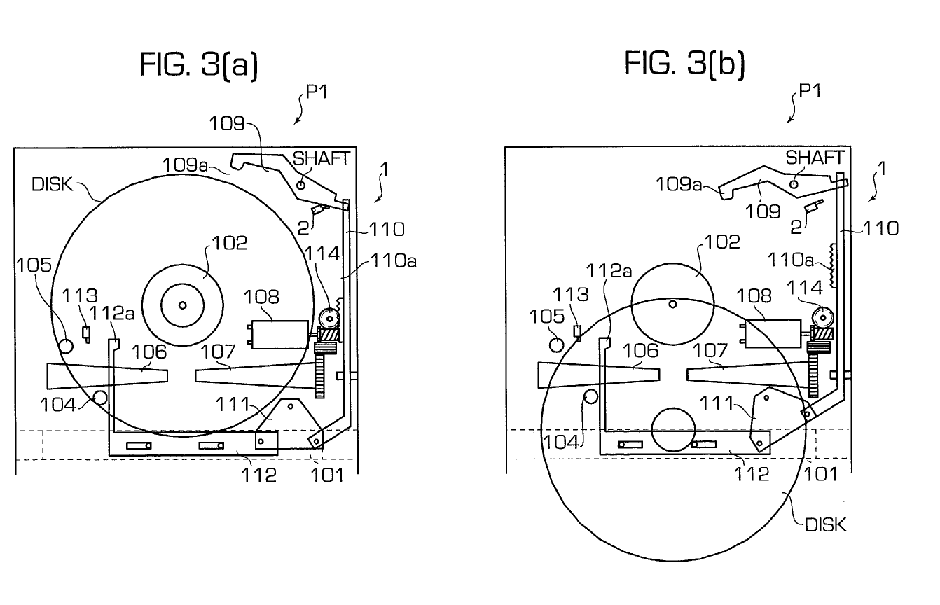

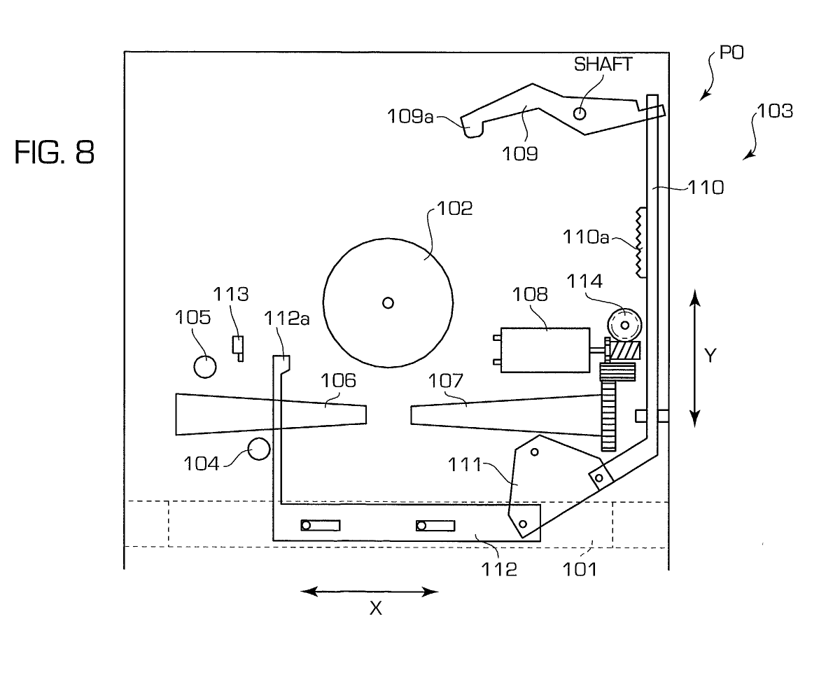

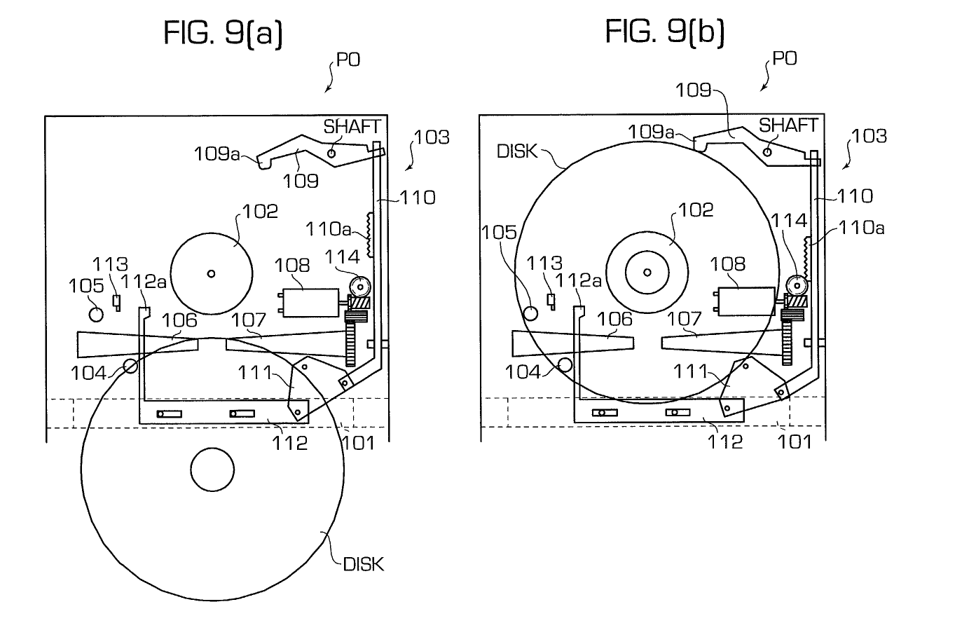

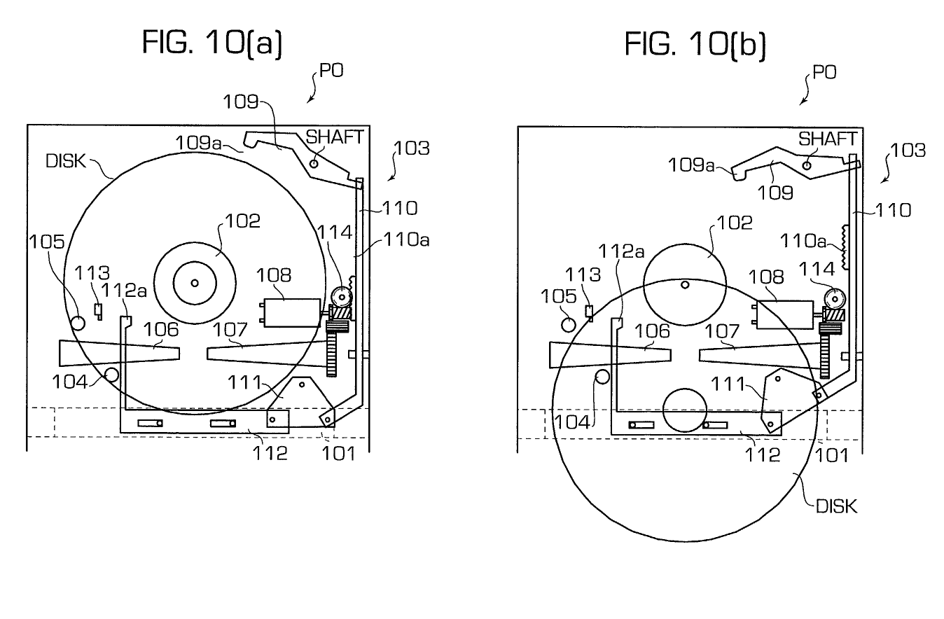

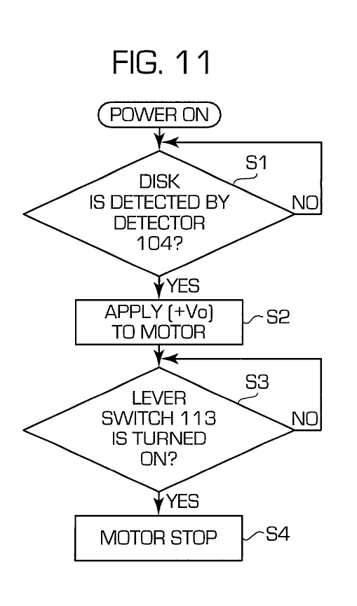

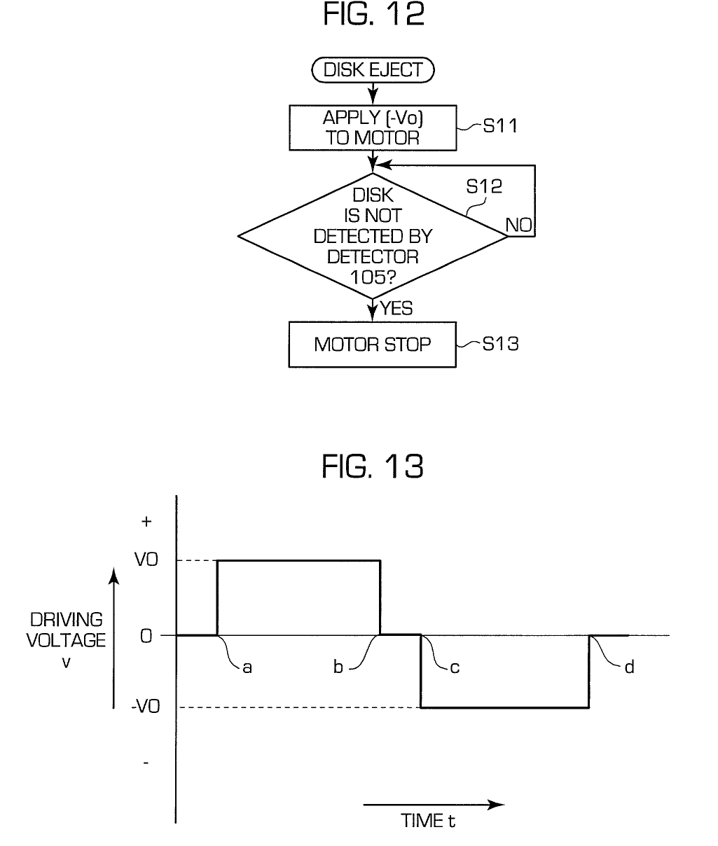

An illustrative, non-limiting example of a disk player P1 in accordance with one embodiment of the present invention is shown in FIG. 1. As in the case of the disk player P0 shown in FIG. 8, the disk player P1 is a “slot-in type” disk reproducing apparatus. However, the present invention is not limited to a “slot-in type” disk reproducing apparatus. Also, FIGS. 2A, 2B, 3A, and 3B are views showing respective positions of a disk within the disk player P1 during a disk loading operation and a disk unloading operation. Specifically, FIG. 2A shows the position of the disk when the disk is located at an insertion position, FIG. 2B shows the position of the disk when the disk is located at a housed position, FIG. 3A shows the position of the disk when the disk is located at a reproduction position, and FIG. 3B shows the position of the disk when the disk is located at an ejection position.

In addition, many of the components and structures contained in the disk player P1 are similar or analogous to the corresponding components and structures contained in the disk player P0 described above. Accordingly, the components and structures that are contained in the disk player P1 and that correspond to the components and structures contained in disk player P0 are designated with the same reference designations. Furthermore, some of the detailed description of such components and structures of the disk player P1 is omitted for the sake of brevity.

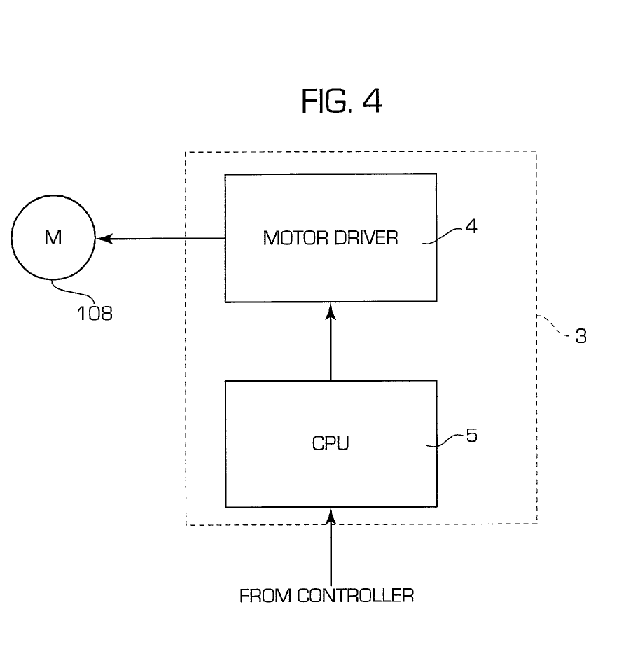

As shown in FIG. 1, the disk player P1 comprises a loading device 1, an insertion hole 101, a turntable 102, and DC motor 108. The insertion hole 101 is located on the front side of the disk player P0, and a disk can be loaded into the player P1 by inserting the disk through the insertion hole 101. When the disk is completely loaded in the player P1, it is mounted on the turntable 102, and the turntable 102 rotates the disk so that information can be reproduced from the disk. Also, the disk player P1 comprises a lever switch 2 and a rotation controller 3 (FIG. 4), which are not contained in the disk player P0 discussed previously.

The loading device 1 includes a loading and unloading mechanism, a clamping mechanism, and a lever slide mechanism. The loading and unloading mechanism transports the disk from the insertion position to the housed position during a disk loading operation and transports the disk from the housed position to the ejection position during an disk unloading operation. The clamping mechanism transports the disk from (or to) the housed position to (or from) the reproduction position during a clamping operation (or a clamp releasing operation), clamps the disk to the turntable 102 during the clamping operation, and unclamps the disk from the turntable 102 during the clamp releasing operation.

As shown in FIG. 1, the lever slide mechanism that contains an arm 109 that is rotatably disposed on a shaft, and the lever switch 2 is provided near the arm 109. When the disk player P1 is initially powered ON and a disk has not been inserted through the insertion hole 101, the arm 109 is separated from the lever switch 2. As a result, the switch 2 is in an OFF state and outputs a switching signal that equals a logic “0” to a controller (not shown).

When the disk is inserted through the insertion hole 101 and reaches the insertion position (FIG. 2A), the rotating rollers 106 and 107 rotate and transport the disk from the insertion position to the housed position (FIG. 2B). Before the disk reaches the housed position, it engages the engagement portion 109a of the arm 109, and as the rollers 106 and 107 continue to transport the disk towards the housed position, the disk pushes the engagement portion 109a and rotates the arm 109 clockwise around its shaft. When the disk reaches the housed position, the arm 109 has been rotated around its shaft such that it is moved adjacent to the lever switch 2 as shown in FIG. 2B and switches the lever switch 2 from the OFF state to the ON state. When the lever switch 2 is in the ON state, it outputs a switching signal that equals a logic “1” to the controller.

As a result of the above configuration, the lever switch 2 detects when the loading and unloading mechanism has finished transporting the disk to the housed position. Furthermore, as shown in FIG. 2B, when the disk reaches the housed position, the rack 110a of the first lever 110 starts to engage the gear 114, and the clamping operation of the clamping mechanism begins. Thus, in addition to detecting when the loading and unloading mechanism has completed the insertion operation and transported the disk to the housed position, the lever switch 2 also detects when the clamping operation of the clamping mechanism begins.

Also, when the disk is clamped to the turntable 102, and the EJECT instruction is input, the clamping mechanism performs the clamp releasing operation. During such operation, the clamping mechanism unclamps the disk from the turntable 102 and transports the disk from the reproduction position (FIG. 3A) to the housed position (FIG. 2B). As the disk moves from the reproduction position to the housed position, the gear 114 rotates and moves the rack 110a and first lever 110 upward in the Y direction shown in FIG. 1 such that the arm 109 rotates counterclockwise around its shaft. (FIGS. 3A and 2B). When the disk reaches the housed position and the clamp releasing operation is completed, the arm 109 moves away from the lever switch 2, and the lever switch 2 is switched from the switch ON state to the OFF state. Thus, the switching signal output from the lever switch 2 changes from a logic “1” to a logic “0”. Accordingly, based on the configuration above, the lever switch 2 can detect when the clamp releasing operation of the disk is completed. Also, since the loading and unloading mechanism begins the ejection operation to transport the disk from the housed position (FIG. 2B) to the ejection position (FIG. 3B) at approximately when the clamp releasing operation is completed, the lever switch 2 also detects when the ejection operation of the loading and unloading mechanism begins.

As in the disk player P0, the disk loading operation comprises the insertion operation performed by the loading and unloading mechanism and the clamping operation performed by the clamping mechanism. Specifically, when a disk is inserted through the insertion hole 101, the loading and unloading mechanism performs the insertion operation by moving the disk from the insertion position (FIG. 2A) to the housed position (FIG. 2B). Then, the clamping mechanism performs the clamping operation by moving the disk from the housed position (FIG. 2B) to the reproduction position (FIG. 3A) and by clamping the disk to the turntable 102.

Also, the disk unloading operation comprises the clamp releasing operation performed by the clamping mechanism and the ejection operation performed by the loading and unloading mechanism. Specifically, when an EJECT instruction is input after a disk has been loaded in the disk player P1, the clamping mechanism performs the clamp releasing operation by unclamping the disk from the turntable 102 and moving the disk from the reproduction position (FIG. 3A) to the housed position (FIG. 2B). Then, the loading and unloading mechanism performs the ejection operation by moving the disk from the housed position (FIG. 2B) to the ejection position (FIG. 3B).

The disk loading operation and the disk unloading operation described above are performed under the control of the controller, and the DC motor 108 supplies the necessary power to the various mechanisms used to perform the disk loading and unloading operations. In addition, as described in more detail below, during the disk loading operation, the controller evaluates the detection signal output from the lever switch 2 to determine if the loading and unloading mechanism has completed the insertion operation and if the clamping mechanism is beginning the clamping operation. Based on such determination, the controller controls the rotation controller 3 (FIG. 4) to increase the revolution rate of the DC motor 108 when the insertion operation is completed and the clamping operation is beginning. As a result, the revolution rate of the DC motor 108 is increased when the load on the DC motor 108 switches from a low load (i.e. when the insertion operation is being performed by the loading and unloading mechanism) to a high load (i.e. when the clamping operation is being performed by the clamping mechanism).

Similarly, as described in more detail below, during the disk unloading operation, the controller evaluates the detection signal output from the lever switch 2 to determine if the clamping mechanism has completed the clamp releasing operation and if the loading and unloading mechanism is beginning the ejection operation. Based on such determination, the controller controls the rotation controller 3 (FIG. 4) to decrease the revolution rate of the DC motor 108 when the clamp releasing operation is completed and the ejection operation is beginning. As a result, the revolution rate of the DC motor 108 is decreased when the load on the DC motor 108 switches from a high load (i.e. when the clamp releasing operation is being performed by the clamping mechanism) to a low load (i.e. when the ejection operation is being performed by the loading and unloading mechanism).

FIG. 4 is a block diagram showing an example of the rotation controller 3. As shown in the figure, the rotation controller 3 comprises a motor driver 4 and a central processing unit (“CPU”) 5. The motor driver 4 generates a driving voltage, and the DC motor 108 rotates at a particular revolution rate in accordance with the driving voltage. Also, the CPU 5 controls the level of the driving voltage generated by the motor driver 4 based on one or more signals output from the controller of the disk player P1.

As described in more detail below, when the controller inputs the detection signal from the lever switch 2 and determines that the insertion operation of the loading and unloading mechanism has been completed and that the clamping operation of the clamping mechanism is beginning, the controller outputs an instruction to the CPU 5. When the CPU 5 receives such instruction, it instructs the motor driver 4 to change the driving voltage supplied to the motor 108 from a predetermined driving voltage +V₁ to a predetermined driving voltage +V₂. Similarly, when the controller inputs the detection signal from the lever switch 2 and determines that the clamp releasing operation of the clamping mechanism has been completed and that the ejection operation of the loading and unloading mechanism is beginning, the controller outputs an instruction to the CPU 5. When the CPU 5 receives such instruction, it instructs the motor driver 4 to change the driving voltage supplied to the motor 108 from a predetermined driving voltage −V₂ to a predetermined driving voltage −V₁.

The value of the driving voltage +V₁ is determined so that the DC motor 108 will rotate at the appropriate number of revolutions necessary for driving the loading and unloading mechanism (i.e. for driving a relatively light load) during the insertion operation. Thus, when the DC motor 108 drives the loading and unloading mechanism while it is performing the insertion operation, the motor 108 does not generate abnormal sounds and brush noises. Also, the driving voltage −V₁ has a polarity opposite to the driving voltage +V₁. Furthermore, the value of the driving voltage −V₁ is determined so that the DC motor 108 will rotate at the appropriate number of revolutions necessary for driving the loading and unloading mechanism (i.e. for driving a relatively light load) during the ejection operation. Thus, when the DC motor 108 drives the loading and unloading mechanism while it is performing the ejection operation, the motor 108 does not generate abnormal sounds and brush noises.

The value of the driving voltage +V₂ is determined so that the DC motor 108 will rotate at the appropriate number of revolutions necessary for driving the clamping mechanism (i.e. for driving a relatively heavy load) during the clamping operation. Thus, when the DC motor 108 drives the clamping mechanism while it is performing the clamping operation, the motor 108 can give adequate driving force to the clamping mechanism. Also, the driving voltage −V₂ has a polarity opposite to the driving voltage +V₂. Furthermore, the value of the driving voltage −V₂ is determined so that the DC motor 108 will rotate at the appropriate number of revolutions necessary for driving the clamping mechanism (i.e. for driving a relatively heavy load) during the clamp releasing operation. Thus, when the DC motor 108 drives the clamping mechanism while it is performing the clamp releasing operation, the motor 108 can give adequate driving force to the clamping mechanism.

In the illustrative, non-limiting embodiment, the driving voltage +V₁ has a magnitude that approximately equal to and a polarity that is opposite to the driving voltage −V₁. Also, in such embodiment, the driving voltage +V₂ has a magnitude that approximately equal to and a polarity that is opposite to the driving voltage −V₂. In addition, the magnitude of the voltage +V₂ (or −V₂) is greater than the magnitude of the voltage +V₁ (or −V₁). However, the relative magnitudes and polarities are merely examples and are not limited to the specific relationships described above.

In any event, based on the above driving voltages +V₂ and +V₁, during the disk loading operation, the rotation controller 3 drives the DC motor 108 with the driving voltage +V₁ when the motor 108 is driving the loading and unloading mechanism during the insertion operation. Thus, the DC motor 108 drives the loading and unloading mechanism (i.e. a relatively light load) by a relatively low driving force. Also, the rotation controller 3 drives the DC motor 108 with the driving voltage +V₂ when the motor 108 is driving the clamping mechanism during the clamping operation. Thus, the DC motor 108 drives the clamping mechanism (i.e. a relatively heavy load) by a relatively high driving force. As a result, the DC motor 108 changes its driving force when the load of the mechanism that it is required to drive changes.

In addition, based on the above driving voltages −V₂ and −V₁, during the disk unloading operation, the rotation controller 3 drives the DC motor 108 with the driving voltage −V₂ when the motor 108 is driving the clamping mechanism during the clamp releasing operation. Thus, the DC motor 108 drives the clamping mechanism (i.e. a relatively heavy load) by a relatively high driving force. Also, the rotation controller 3 drives the DC motor 108 with the driving voltage −V₁ when the motor 108 is driving the loading and unloading mechanism during the ejection operation. Thus, the DC motor 108 drives the loading and unloading mechanism (i.e. a relatively light load) by a relatively low driving force. As a result, the DC motor 108 changes its driving force when the load of the mechanism that it is required to drive changes.

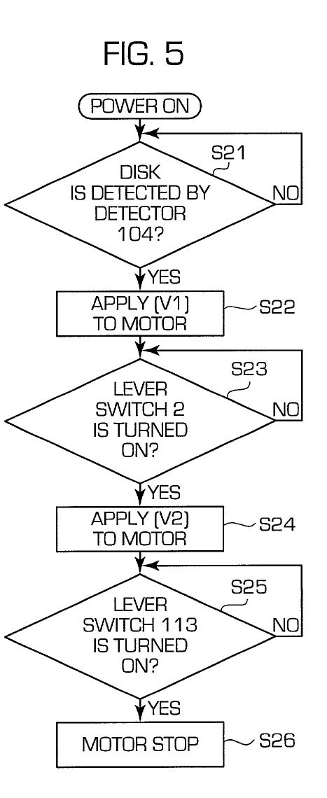

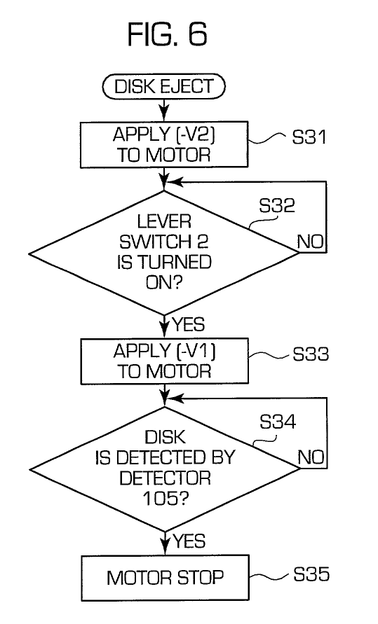

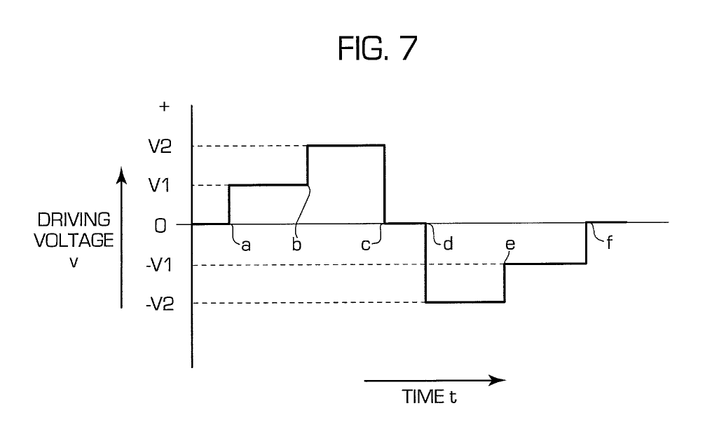

The disk loading operation and the disk unloading operation of the disk player P0 will be described below in more detail with reference to FIGS. 2A-7. FIG. 5 shows a flowchart of a disk loading procedure executed by the controller during the disk loading operation, and FIG. 6 shows a flowchart of a disk unloading procedure executed by the controller during the disk unloading operation. Also, FIG. 7 illustrates a waveform diagram of a driving voltage applied to the DC motor 108 by the rotation controller 3 during the disk loading operation and the disk unloading operation. More specifically, FIG. 7 shows waveform of the driving voltage when the disk unloading operation is performed after the disk loading operation.

Disk Loading Operation

After power is initially supplied to the disk player P1 and before a disk is inserted into the insertion slot 101, the detector 104 does not detect the presence of a disk at the insertion position, the detector 105 does not detect the presence of a disk at the ejection position, the lever switch 113 does not detect the presence of the disk at the reproduction position, and the lever switch 2 is turned OFF. Thus, the controller determines that a disk is not present within the player P0 and does not drive the DC motor 108.

Accordingly, as shown in FIG. 5, after power is initially supplied to the disk player P1, the controller determines if the detection output of the detector 104 equals a logic “1” (e.g. if the detector 104 detects the presence of a disk) or if the detection output of the detector 104 equals a logic “0” (e.g. if the detector 104 does not detect the presence of a disk). (Operation S21). If the detection output of the detector 104 is equal to a logic “0”, the controller determines that a disk is not located at the insertion position of the disk player P1, and operation S21 is repeated. If the detection output of the detector 104 equals a logic “1”, the controller determines that the disk is located at the insertion position (FIG. 2A). (Operation S21).

When the controller determines that a disk is located at the insertion position, the controller instructs the rotation controller to apply the driving voltage +V₁ to the DC motor 108 to instruct the motor 108 to rotate in a first direction and at a first revolution rate at time “a” (FIG. 7). (Operation S22). When the DC motor 108 rotates in the first direction, the rollers 106 and 107 of the loading and unloading mechanism rotate such that they move the disk from the insertion position towards the housing position (FIG. 2B).

After the driving voltage +V₁ is applied to the motor 108, the controller determines if the lever switch 2 is ON and is outputting a switching signal that equals a logic “1” (Operation S23). If the switching signal equals a logic “0” (i.e. if the disk is not located in the housed position (FIG. 2A)), the controller repeats operation S23. On the other hand, if the switching signal equals a logic “1” (i.e. if the disk is located in the housed position (FIG. 2B)), the controller instructs the rotation controller 3 to stop supplying the driving voltage +V₁ to the DC motor 108 and to start supplying the driving voltage +V₂ to the motor 108 at time “b” (FIG. 7). (Operation S24). When the driving voltage +V₂ is applied to the DC motor 108, the motor 108 rotates at a higher revolution rate. Thus, the driving voltage +V₂ is applied to the motor 108 at the time “b” because, once the disk reaches the housed position, the DC motor 108 ceases driving the loading and unloading mechanism (having a relatively light load) and begins driving the clamping mechanism (having a relatively heavy load).

After the driving voltage +V₂ is applied to the motor 108, the controller determines if the lever switch 113 is ON and is outputting a switching signal that equals a logic “1” (Operation S25). If the switching signal equals a logic “1” (i.e. if the disk is located in the reproduction position (FIG. 3A) and clamped to the turntable 102), the controller stops supplying the driving voltage +V₂ to the DC motor 108 at time “c” (FIG. 7), and the motor 108 stops rotating. (Operation S26). On the other hand, if the switching signal equals a logic “0” (i.e. if the disk is not located in the reproduction position (FIG. 3A) and is not clamped to the turntable 102), the controller repeats operation S26.

During the operation S22, the controller instructs the rotation controller 3 to apply the driving voltage +V₁ to the DC motor 108 to rotate the rollers 106 and 107 of the loading and unloading mechanism. When the rollers 106 and 107 are rotated, the disk is pulled into the disk player P1 through the insertion slot 101 and is transported horizontally towards the housed position (FIG. 2B). As the disk is being moved to the housed position, it engages the engagement portion 109a of the arm 109 before it reaches the housed position. Then, the rollers 106 and 107 continue to move the disk horizontally to the housed position and cause the disk to push the arm 109 and rotate it around its shaft.

After the disk reaches the housed position, the arm 109 moves adjacent to the lever switch 2 and turns the switch 2 ON. When the lever switch 2 turns on, the controller instructs the rotation controller 3 to apply the driving voltage +V₂ to the DC motor 108. Also, after the disk reaches the housed position, the rack 110a engages the gear 114, and the DC motor 108 drives the gear 114 such that the rack 110a and the first lever 110 move downward in the Y direction shown in FIG. 1. At the time that the gear 114 engages the rack 110a and begins to move the first lever 110 downward, the driving force of the DC motor 108 is transmitted to the clamping mechanism. When the clamping mechanism receives the driving force from the DC motor 108, it moves the rotating rollers 106 and 107 downward, along with the disk, and mounts the disk on the turntable 102. After the disk is clamped to the turntable 102, the rotating rollers 106 and 107 are further lowered so that they are separated from the disk, and the clamping operation is completed. After such operations, the disk is located at the reproduction position (FIG. 3A).

As shown in FIG. 3A, when the disk is in the reproduction position after the clamping operation, the engagement portion 112a of the second lever 112 is located adjacent to the lever switch 113 and turns ON the lever switch 113. Thus, the switching signal output from the switch 113 to the controller equals a logic “1”, and the controller stops applying the driving voltage +V₂ to the DC motor 108. Thus, when the controller detects that the lever switch 113 is switched from OFF to ON, it determines that the clamping operation of the disk is completed and stops driving the DC motor 108. As a result, the disk loading operation is completed.

Disk Unloading Operation

When a disk is located in the reproduction position (FIG. 3A) and the clamping operation by the clamping mechanism has been completed, an EJECT instruction may be input to eject the disk from the disk player P1 by pressing an EJECT button or the like on the disk player P1. Accordingly, as shown in FIG. 6, when the EJECT button is pressed, the controller instructs the rotation controller 3 to apply the driving voltage −V₂ to the DC motor at the time “d” (FIG. 7). (Operation S31). After the driving voltage −V₂ is applied to the motor 108, the controller determines if the lever switch 2 is OFF and is outputting a switching signal that equals a logic “0” (Operation S32). If the switching signal equals a logic “1” (i.e. if the disk is not located in the housed position (FIG. 2B)), the controller repeats operation S32. On the other hand, if the switching signal equals a logic “0” (i.e. if the disk has reached the housed position (FIG. 2B)), the controller instructs the rotation controller 3 to stop supplying the driving voltage −V₂ to the DC motor 108 and to start supplying the driving voltage −V₁ to the motor 108 at time “e” (FIG. 7). (Operation S33). When the driving voltage −V₁ is applied to the DC motor 108, the motor 108 rotates at a lower revolution rate. Thus, the driving voltage −V₁ is applied to the motor 108 at the time “e” because, once the disk reaches the housed position, the DC motor 108 ceases driving the clamping mechanism (having a relatively heavy load) and begins driving the loading and unloading mechanism (having a relatively light load).

Subsequently, the controller evaluates the detection output signal from the detector 105 to determine if the signal equals a logic “0” (i.e. the disk has reached the ejection position) or if the signal equals a logic “1” (i.e. the disk has not reached the ejection position). If the controller determines that the disk is not located at the ejection position, operation S34 is repeated. On the other hand, if the controller determines that the disk is located at the ejection position, it stops driving the DC motor 108 at the time “f” (FIG. 7). (Operation S35). As a result, the disk unloading operation of the disk is completed.

As noted above, when the EJECT button is pressed, the controller instructs the rotation controller 3 to apply the driving voltage −V₂ to the DC motor 108 at the time “d” (FIG. 7) to drive the motor 108 in a second direction at an increased revolution rate. The second direction in which the motor 108 is driven is opposite to the first direction mentioned above. When the DC motor 108 rotates in the second direction, the clamping mechanism performs a clamp releasing operation to release the disk from the turntable 102 and raises the disk from the reproduction position (FIG. 3A) to the housed position (FIG. 2B). Furthermore, in order to raise the disk from the reproduction position to the housed position, the rollers 106 and 107 are raised upward, positioned under the disk on the turntable 102, and lift the disk up from the turntable 102 to the housed position. After the rollers 106 and 107 lift the disk up to the housed position, the vertical movement of the rollers 106 and 107 ceases, and the clamp releasing operation of the clamping mechanism is completed. At the same time that the clamp releasing operation is being performed, the gear 114 moves the rack 110a and the first lever 110 upwards in the Y direction shown in FIG. 1, and the rack 110a becomes disengaged from the gear 114 at approximately the time when the clamp releasing operation is completed and the disk reaches the housed position.

After the disk is located in housed position, the controller instructs the rotation controller 3 to apply the driving voltage −V₁ to the DC motor 108 at the time “e” (FIG. 7) to drive the motor 108 in the second direction at a decreased revolution rate. Moreover, after the disk is located in the housed position, the rotation of the DC motor 108 is coupled to the rollers 106 and 107 so that they rotate and horizontally move the disk from the housed position towards the ejection position (FIG. 3B).

As described above, the loading and unloading mechanism is driven by the DC motor 108 when the motor 108 is driven by the voltage +V₁ (or −V₁) and rotating at a decreased revolution rate. Also, the clamping mechanism is driven by the DC motor 108 when the motor 108 is driven by the voltage +V₂ (or −V₂) and rotating at an increased revolution rate. Thus, the motor 108 drives the loading and unloading mechanism and the clamping mechanism at respective driving forces corresponding to their respective loads on the motor 108. As a result, the DC motor 108 operates smoothly during each of the operations performed by the mechanisms, and the abnormal sounds and brush noises of the DC motor 108 are suppressed.

In the embodiment described above, the DC motor 108 is used as the power source for driving the loading and unloading mechanism and the clamping mechanism. Clearly, the present invention is not limited to the use of a DC motor, and a stepper motor or any other power source may be used.

Also, in the embodiment described above, the disk player P1 is a “slot-in type” disk player. However, the present invention is not limited to such a disk player and may be incorporated into virtually any type of recording and/or reproducing apparatus. For instance, the present invention may be used in a tray type recording and/or reproducing apparatus, in which a recording medium is supplied to the apparatus or removed from the apparatus by a tray. As another example, the present invention may be used in a magazine type recording and/or reproducing apparatus in which a plurality of information recording media are housed.

Also, as described above, the driving voltage applied to the motor 108 is changed when the motor 108 switches between driving the loading and unloading mechanism and the clamping mechanism. However, the present invention is clearly not limited to such an implementation, and the driving voltage applied to the motor 108 may be changed at any point in time when the load on the motor 108 changes. For instance, the voltage applied to the motor 108 may be changed when the motor switches from driving mechanisms other than the mechanisms described above. Furthermore, voltage applied to the motor may be changed during the time the motor 108 is driving a single mechanism, if the load of the single mechanism changes while the motor 108 is driving it.

Also, in the embodiment described above, the driving voltages applied to the various mechanisms during the disk loading operation and the driving voltages applied to the various mechanisms during the disk unloading operation have equal magnitudes but have different polarities. However, the information recording and/or reproducing apparatus of the present invention is not limited to such a scenario. For example, when the load on the motor 108 is different during the disk loading operation and the disk unloading operation, driving voltages having different magnitudes corresponding to the different loads may be applied to the motor.

Furthermore, in the examples of the embodiments described above, the disk player P1 reproduces an optical disk such as a CD or a DVD. However, the present invention is not limited to such an implementation and may be used in a recording and/or reproducing apparatus that records and/or reproduces virtually any type of recording medium.

The previous description of the preferred embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents thereof.

What is claimed is:

1. An information recording and/or reproducing apparatus, comprising:
a recording and/or reproducing device that records and/or reproduces information to and/from an information medium;
a transportation device that transports said information medium along a transportation path between a loading area and said recording and/or reproducing device;
a power source that supplies power to said transportation device, wherein said transportation device imparts a first load on said power source when said transportation device transports said information medium along a first portion of said transportation path, and wherein said transportation device imparts a second load on said power source when said transportation device transports said information medium along a second portion of said transportation path; and
a controller that applies a first driving signal to drive said power source when said transportation device transports said information medium along said first portion of said transportation path and that applies a second driving signal to drive said power source when said transportation device transports said information medium along said second portion of said transportation path,
wherein said first driving signal is different than said second driving signal.

2. The apparatus as claimed in claim 1, wherein at least one characteristic of said first driving signal is determined based on said first load and at least one characteristic of said second driving signal is determined based on said second load.

3. The apparatus as claimed in claim 1, wherein a magnitude of said first driving signal is different than a magnitude of said second driving signal.

4. The apparatus as claimed in claim 1, wherein said transportation device comprises:
a first loading device that transports said information medium from said loading area to an intermediate position between said loading area and said recording and/or reproducing device, wherein said first portion of said transportation path is located between said loading area and said intermediate position; and
a second loading device that transports said information medium from said intermediate position to said recording and/or reproducing device, wherein said second portion of said transportation path is located between said intermediate position and said recording and/or reproducing device,
wherein said controller applies said first driving signal to said power source when said first loading device transports said information medium and applies said second driving signal to said power source when said second loading device transports said information medium.

5. The apparatus as claimed in claim 4, wherein said first loading device is a loading device that transports said information medium from said loading area to a housed position, and
wherein said second loading device is a clamping device that transports said information medium from said housed position to said recording and/or reproducing device and secures said information medium to said recording and/or reproducing device.

6. The apparatus as claimed in claim 1, wherein said transportation path comprises:
a first transportation path that transports said information medium from a loading area to said recording and/or reproducing device; and
a second transportation path that transports said information medium from said recording and/or reproducing device to an unloading area,
wherein said first portion of said transportation path is contained in said first transportation path and said second portion of said transportation path is contained in said second transportation path.

7. The apparatus as claimed in claim 6, wherein said transportation path comprises:
a third portion that is contained in said first transportation path; and
a fourth portion that is contained in said second transportation path,
wherein said transportation device imparts a third load on said power source when said transportation device transports said information medium along said third portion of said transportation path,
wherein said transportation device imparts a fourth load on said power source when said transportation device transports said information medium along said fourth portion of said transportation path,
wherein said controller applies a third driving signal to drive said power source when said transportation device transports said information medium along said third portion of said transportation path and applies a fourth driving signal to drive said power source when said transportation device transports said information medium along said fourth portion of said transportation path, and
wherein said first drive signal, said second drive signal, said third drive signal, and said fourth drive signal are different from each other.

8. The apparatus as claimed in claim 7, wherein said first drive signal and said third drive signal have a first polarity, and
wherein said second drive signal and said fourth drive signal have a second polarity different from said first polarity.

9. The apparatus as claimed in claim 8, wherein said first drive signal has a magnitude that is less than a magnitude of said third drive signal, and
wherein said second drive signal has a magnitude that is less than a magnitude of said fourth drive signal.

10. The apparatus as claimed in claim 9, wherein said magnitude of said first drive signal is approximately equal to said magnitude of said second drive signal.

11. A method of transporting an information medium via a transportation device along a transportation path between a loading area and a recording and/or reproducing device of an information recording and/or reproducing apparatus, comprising:
(a) determining if said information medium is to be transported along a first portion of said transportation path;
(b) if said information medium is to be transported along said first portion of said transportation path, supplying a first drive signal to a power source of said transportation device;
(c) determining if said information medium is to be transported along a second portion of said transportation path; and
(d) if said information medium is to be transported along said second portion of said transportation path, supplying a second drive signal to said power source, wherein said second drive signal is different than said first drive signal.

12. The method as claimed in claim 11, wherein said transportation device imparts a first load on said power source when said transportation device transports said information medium along said first portion of said transportation path, and
wherein said transportation device imparts a second load on said power source when said transportation device transports said information medium along said second portion of said transportation path.

13. The method as claimed in claim 12, wherein at least one characteristic of said first driving signal is determined based on said first load and at least one characteristic of said second driving signal is determined based on said second load.

14. The method as claimed in claim 11, wherein a magnitude of said first driving signal is different than a magnitude of said second driving signal.

15. The method as claimed in claim 11, wherein said operation (a) comprises:
(a1) determining if said information medium is located at a first predetermined position of said first portion of said transportation path; and
(a2) determining that said information medium is to be transported along said first portion of said transportation path if said information medium is located at said first predetermined position.

16. The method as claimed in claim 15, wherein said second portion of said transportation path is located between said first portion of said transportation path and said recording and/or reproducing device, and
wherein said operation (c) comprises:
(c1) determining if said information medium is located at a second predetermined position of said second portion of said transportation path; and
(c2) determining that said information medium is to be transported along said second portion of said transportation path if said information medium is located at said second predetermined position.
